(19) United States
(12) Patent Application Publication
(10) Pub. No.: US 2008/0300951 A1
(43) Pub. Date: Dec. 4, 2008

(54) DYNAMIC STAFFING USING POPULATION COUNT

(75) Inventor: Robert KELLY, Palo Alto, CA (US)

Correspondence Address: BEYER WEAVER LLP, P.O. BOX 70250, OAKLAND, CA, 94612-0250, US

(73) Assignee: CISCO TECHNOLOGY, INC., San Jose, CA (US)

(21) Appl. No.: 11/757,884

(22) Filed: Jun. 4, 2007

(51) Int. Cl. G06F 9/46

(52) U.S. Cl. 705/8

(57) ABSTRACT

In one embodiment, data is received from a monitoring device that monitors population at a location within a facility. Then the data is used to determine a staffing count. A list of employees is then requested from a staffing application. Coordination then occurs with a call manager application to notify employees on the list of employees that their presence is requested, the coordinating using the staffing count to determine when to stop notifying employees.

### BACKGROUND

1. Technical Field

The present disclosure relates to computer networking.

2. Description of the Related Art

Large retailers and other businesses often utilize a dynamic staffing model, where managers call in extra employees when business gets busy and reduce staffing when business slows. Many such businesses also have some level of video surveillance to aid in the prevention/detection of crime.

### BRIEF DESCRIPTION OF THE DRAWINGS

FIG. 1 illustrates an example system for dynamic staffing.

FIG. 2 illustrates an example method for dynamic staffing.

FIG. 3 illustrates an example apparatus for dynamic staffing.

### DESCRIPTION OF EXAMPLE EMBODIMENTS

### Overview

In one embodiment, data is received from a monitoring device that monitors population at a location within a facility. Then the data is used to determine a staffing count. A list of employees is then requested from a staffing application. Coordination then occurs with a call manager application to notify employees on the list of employees that their presence is requested, the coordinating using the staffing count to determine when to stop notifying employees.

### Example Embodiments

In this application, numerous specific details are set forth in order to provide a thorough understanding of the present invention. It will be obvious, however, to one skilled in the art, that the present invention may be practiced without some or all of these specific details. In other instances, well known process steps have not been described in detail in order to not obscure the present invention.

In one embodiment, video surveillance is utilized with specialized software that aid in assessing true demand for services in any location. This information is then tied into a centralized application such as a unified communications application to derive different customer benefits. For example, the application may be tied to an outdial application to call workers into the office, store, etc. when demand reaches a certain threshold. This aids in reducing labor cost as well as improving customer satisfaction. It also obtains these benefits with no or minimal effort on the part of managers, freeing up their time to devote to other activities. In a retail environment, the system may further be configured to alert employees already on the flow that there is a congregation of customers in a certain aisle or department so that the employees may be redirected there. It should be noted that the advantages described above and throughout the rest of this document do not in any way suggest that any of the embodiments necessarily provides all of the described advantages or that all of the embodiments of the invention necessarily provide any one of the described advantages.

In one embodiment, an Internet Protocol (IP)-based video surveillance system is utilized to capture real-time images of the relevant locations. These locations may include any location where customer congestion would relate to a need to add additional employees. Common examples would include entrances/exits, checkout lines, aisles, departments, bathrooms, etc. A mechanism may then be used to recognize, based on the real-time images, that there is congestion. This mechanism may be, for example, pattern recognition software that analyzes the real-time images to detect faces/bodies and movement to attempt to count the number of people at a location. Alternatively, this mechanism may be a network traffic mining system that checks for a sustained burst of traffic from an IP-based camera. The latter embodiment works on the principle that an IP-based camera may use compression techniques on data that are related to changes in the images from frame to frame−less movement equals more compression and reduced network traffic from the camera.

Embodiments are also envisioned wherein coordination occurs between multiple cameras to get an accurate estimate of customer count. This may include multiple cameras at the same location from different angles, but might also include coordination between cameras at different locations throughout the facility.

The system may include an interface between the video surveillance application and a customer staffing application. In one embodiment, the customer staffing application is not altered so that existing customer staffing applications can be given the benefits of the embodiment of the present invention without additional costs or efforts by the facility owner.

A voice portal may be utilized with the staffing application to automatically call employees when needed. The voice portal may utilize a call list from the staffing application to begin calling employees not currently on duty to see if they can come into work. Upon connection to an employee, the voice portal may provide a prompt where the user can use voice commands or number keys to select an appropriate response (e.g., accept request or reject request). Additional capability may be provided to help determine how quickly they can be at work if they are accepted or whether they could work later that day if requested later. For example, employees may be provided with cellular phones that include global positioning system (GPS) equipment. The voice portal may determine, using the GPS information, the location of the employee and determine how long it should take for the employee to come in. The GPS information may also be utilized in determining whether to call the employee in the first place (e.g., if the user is on vacation and out of the state, the voice portal will not call them). Once the required number of employees have accepted, the voice portal may end the script.

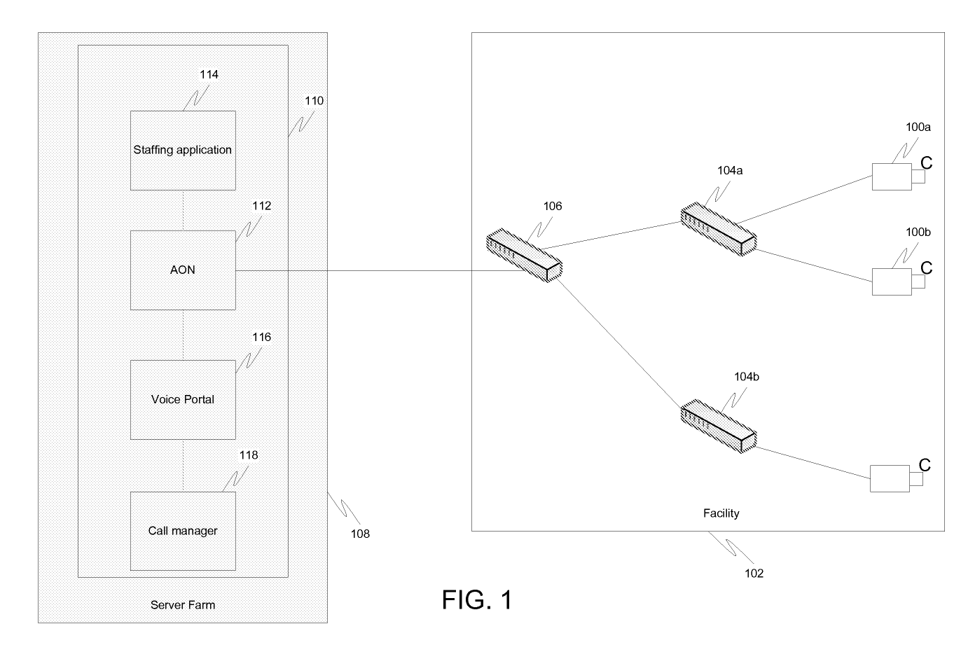

FIG. 1 illustrates an example system for dynamic staffing. One or more IP-enabled video cameras 100a, 100b may be located at a facility 102. Traffic from these cameras 100a, 100b may pass through a switch 104a. Depending upon the size of the facility 102, a distribution switch 106 may also be utilized, which links multiple switches 104a, 104b. The traffic from switches 104a, 104b, 106 may eventually make its way to server farm 108. The server farm 108 may include multiple servers that distribute data center applications 110. The server farm 108 may be located at the same or different locations as the facility 102, and the individual servers at the server farm 108 may also be distributed among many different locations.

In one embodiment, an application-oriented networking (AON) application 112 may monitor the IP traffic from the cameras 100a, 100b to determine whether the traffic indicates an increase or decrease in customer count (e.g., by looking for traffic bursts). In an alternative embodiment, pattern recognition software is utilized to examine the images from the cameras 100a, 100b themselves for the same purpose. In another embodiment, either of these two applications can be combined with a door monitoring application, or may even be replaced by door monitoring application, to count the customers. It should be noted that the AON application may be embodied in software, hardware, or any combination thereof.

Referring back to the embodiment in FIG. 1, AON application 112 interfaces with a staffing application 114 to obtain a list of employees to notify. The functionality that determines the number of employees to notify and what to notify them of may reside in AON application 112, staffing application 114 or in an interface application between them. The list of employees may then be passed to a voice portal 116. It should be noted that this list may either be passed directly from the staffing application 114 to the voice portal, or alternatively the AON application 112 (or interface application) may retrieve the list from the staffing application 114 and pass it to the voice portal 116. The voice portal 116 may then notify employees on the list via a public switched telephone network (PSTN) and return the results to the AON application 112, staffing application 114, or interface application. A call manager application 118 may be utilized in conjunction with the voice portal 116. A call manager application may be any application that manages outgoing communications to individuals. The call manger application 118 may execute a calling script to actually place the call though the voice portal 116.

An embodiment is also envisioned where the customer count information is integrated with a graphical user interface that allows managers to visually monitor traffic and traffic patterns. This allows managers to be involved in the dynamic staffing process to the degree desired.

While the present document describes use of embodiments of the invention at retailers and facilities, it should be noted that many different types of businesses and services could benefit from the use of the present invention, including, for example, airports, hospitals, and sports venues.

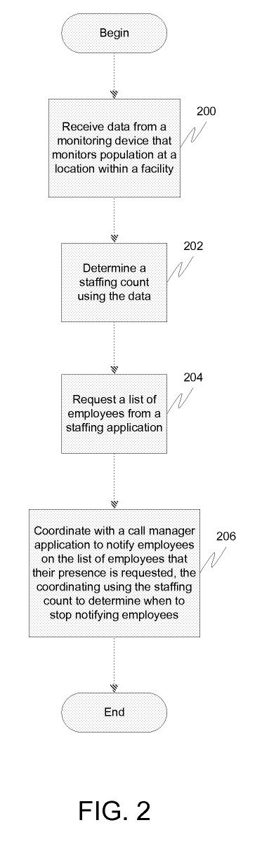

FIG. 2 illustrates an example method for dynamic staffing. The steps of the method may be performed by an AON application. At 200, data is received from a monitoring device that monitors population at a location within a facility. The monitoring device may be, for example, an IP-enabled camera or a door-monitoring device. At 202, a staffing count is determined using the data. For purposes of this document, the term “staffing count” shall refer to a count of employees needed to staff the facility or location. This may either be an overall count of the total number of employees needed, or may simply be the number of additional employees needed to be added. This step may also utilize data from one or more other monitoring devices. The determination may include examining the data for traffic bursts, wherein traffic bursts indicate increases in population at the location. Alternatively it may include examining image information in the data and performing pattern recognition on the image information to determine population count at the location. Alternatively, the data from, for example, a door monitoring device may arrive already having population count embedded within it.

The determination may involve the access of various data structures containing ratios or other values that indicate how many employees need to be staffed for the number of likely customers. For example, one department of a store may have a ratio stored in a data structure indicating that one employee is needed for every ten customers in the department. Another department may have a ratio stored in a data structure indicating that one employee is needed for every twenty customers in the department. This information may then be used in the determination step to aid in the computation of the staffing count.

At 204, a list of employees is requested from a staffing application. In one embodiment, this list may be a single employee, as the system may be designed to request one employee at a time from the staffing application and then call that employee. Alternatively, the list may include all potentially available employees. Embodiments are also foreseen wherein the list may be any length. At 206, coordination occurs with a call manager application to notify employees on the list of employees that their presence is requested. This may include using the staffing count to staff to determine when to stop notifying employees. For example, the call manager application may utilize a voice portal to notify employees via a PSTN. After this method is executed, notification may be received from one or more employees that they accept the request for their presence. The staffing application may be alerted of the notification and information relating to population at locations within a facility may be presented via a graphical user interface. The graphical user interface may be utilized by, for example, a manager in taking various actions relating to the notification of employees. For example, the manager may override some or all of the automated notifications of employees. This might include adding or subtracting employees to or from the list of employees to notify. This might also include taking actions only peripherally related to the notification of employees, such as preparing paperwork, obtaining office supplies, or setting up equipment in anticipation of additional employees showing up for work.

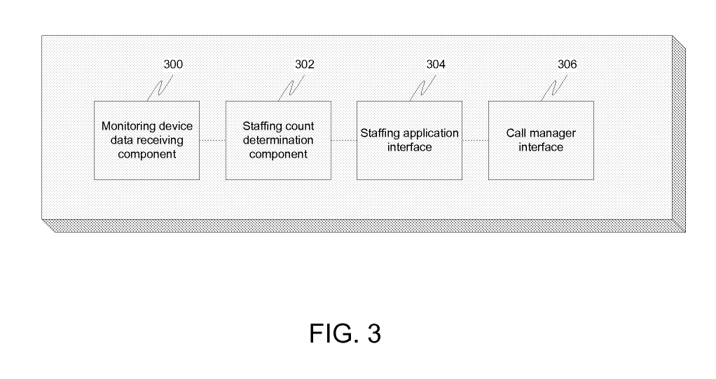

FIG. 3 illustrates an example apparatus for dynamic staffing. This apparatus may be, for example, a switch or software operating on a general purpose computer. If the apparatus is or contains hardware, the apparatus may include a processor and/or memory as well. This apparatus may be embedded into, for example, an AON application, but embodiments are also foreseen wherein all of the components of the apparatus are embodied into other elements of a dynamic staffing system, or wherein some component of the apparatus are located in different elements of a dynamic staffing system from other components of the apparatus. A monitoring device data receiving component 300 may be configured to perform step 200 of FIG. 2. A number of employees to staff determination component 302 may be configured to perform step 202 of FIG. 2. A staffing application interface 304 may be configured to perform step 204 of FIG. 2. A call manager interface 306 may be configured to coordinate with a call manager application to notify employees on the list of employees that their presence is requested. It should be noted that while the above describes individual components, the components themselves may be combined in any permutation, and individual components may also be split into two or more components.

In one embodiment, additional information regarding how many people enter and exit the facility and/or approximately how long on average the number of people currently in the facility will stay may be used in conjunction with, or in lieu of, the video surveillance.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method comprising:
receiving data from a monitoring device that monitors population at a location within a facility;
determining, using the data, a staffing count;
requesting a list of employees from a staffing application; and
coordinating with a call manager application to notify one or more employees on the list of employees that their presence is requested, the coordinating using the staffing count to determine when to stop notifying employees.

2. The method of claim 1, wherein the monitoring device is an Internet Protocol (IP) enabled video camera.

3. The method of claim 2, wherein the determining also utilizes data from another IP enabled video camera.

4. The method of claim 1, wherein the determining includes examining the data for traffic bursts, wherein traffic bursts indicate increases in population at the location.

5. The method of claim 1, wherein the determining includes:
examining image information in the data; and
performing pattern recognition on the image information to determine population count at the location.

6. The method of claim 1, wherein the monitoring device is a door monitoring device.

7. The method of claim 1, wherein the call manager application utilizes a voice portal to notify employees via a public switched telephone network (PSTN).

8. The method of claim 1, wherein the steps of the method are performed by an application oriented networking application.

9. The method of claim 1, further comprising presenting, via a graphical user interface, information relating to population at locations within a facility.

10. The method of claim 1, further comprising:
receiving notifications from one or more employees that they accept the request for their presence; and
alerting the staffing application of the notifications.

11. An apparatus comprising:
a monitoring device data receiving component configured to receive data from a monitoring device that monitors population at a location within a facility;
a staffing count determination component configured to determine, using the data, a staffing count;
a staffing application interface configured to request a list of employees from a staffing application; and
a call manager interface configured to coordinate with a call manager application to notify one or more employees on the list of employees that their presence is requested, the coordinating using the staffing count to determine when to stop notifying employees.

12. The apparatus of claim 11, wherein the monitoring device is an Internet Protocol (IP) enabled video camera.

13. The apparatus of claim 12, wherein the determining also utilizes data from another IP enabled video cameras.

14. The apparatus of claim 11, wherein the determining includes examining the data for traffic bursts, wherein traffic bursts indicate increases in population at the location.

15. The apparatus of claim 11, wherein the determining includes:
examining image information in the data; and
performing pattern recognition on the image information to determine population count at the location.

16. An apparatus comprising:
means for receiving data from a monitoring device that monitors population at a location within a facility;
means for determining, using the data, a staffing count;
means for requesting a list of employees from a staffing application; and
means for coordinating with a call manager application to notify one or more employees on the list of employees that their presence is requested, the coordinating using the staffing count to determine when to stop notifying employees.

17. The apparatus of claim 16, wherein the monitoring device is an Internet Protocol (IP) enabled video camera.

18. The apparatus of claim 17, wherein the means for determining also utilizes data from another IP enabled video camera.

19. The apparatus of claim 16, wherein the means for determining includes means for examining the data for traffic bursts, wherein traffic bursts indicate increases in population at the location.

20. The apparatus of claim 16, wherein the means for determining includes:
means for examining image information in the data; and
means for performing pattern recognition on the image information to determine population count at the location.
